(19) United States
(12) Patent Application Publication
(10) Pub. No.: US 2006/0055805 A1
(43) Pub. Date: Mar. 16, 2006

(54) Information switch and method for a digital camera

(76) Inventors: Kenneth R. Stockton, Fort Collins, CO (US); Michael P. Fennelly, Loveland, CO (US)

Correspondence Address: HEWLETT-PACKARD COMPANY;Intellectual Property Administration, P.O. Box 272400, Fort Collins, CO, 80527-2400, US

(21) Appl. No.: 11/264,922

(22) Filed: Nov. 1, 2005

Related U.S. Application Data
(63) Continuation of application No. 09/813,762, filed on Mar. 21, 2001.

(51) Int. Cl. H04N 5/222

(52) U.S. Cl. 348/333.01

(57) ABSTRACT

Digital cameras and methods of using digital cameras are disclosed herein. An embodiment of a digital camera comprises a display and a help switch. The help switch causes the digital camera to enter a help mode when it is activated. In addition help information that informs a user of various functions associated with operating the digital camera when the help switch is displayed on the display.

This application is a Continuation of a U.S. application, Ser. No. 09/813,762 filed on Mar. 21, 2001, which is hereby incorporated by reference for all that is disclosed therein.

### BACKGROUND

Digital cameras are used to generate machine-readable image data representative of objects. The process of generating image data representative of an object is sometimes referred to as “imaging” or “capturing” the object. The image data may be downloaded from memory within the digital camera to a processor or a printer that replicates the image of the object. Many digital cameras allow users to process the image data in order to manipulate the images representative of the objects. In addition to processing the image data, the user is able to delete selected images from the memory within the digital camera and downloaded image data representative of selected images.

Some of the functions available with a digital camera include, macro and telephoto modes, automatic focusing, video recording, time lapse photography, audio recording, and lighting adjustments. Several controls, such as knobs and switches, on the digital camera operate these functions. In some digital cameras, these functions are accessed and activated by way of a pull down menu displayed on a display device. One problem with digital cameras is that there is no way for a user to understand how to use all the functions of the digital camera without referring to an operating manual while he or she is trying to take pictures. Accordingly, a digital camera user may not be using the functions of the digital camera to their full potential.

As more image data processing techniques are added to digital cameras, the digital cameras become more complicated to operate to their full potential. In some situations, a user may not understand how to use all the functions offered with a digital camera without having a manual available while operating the digital camera. Therefore, as described above, a user of a digital camera may not be able to utilize all the functions offered by the digital camera.

Furthermore, digital cameras are becoming smaller and more compact. Therefore, the space available on the body of the digital camera for switches and knobs used to operate the functions is decreasing. In order to overcome this problem, a single switch or knob may operate a plurality of different functions. This causes the operation of the digital camera to become more complex because the user may not be aware of or remember all the functions accessible by way of a single switch or knob. Therefore, even though the digital camera has more functions, a user may not be aware of how to use these functions.

### BRIEF DESCRIPTION OF THE DRAWINGS

FIG. 1 is an exemplary rear perspective view of a digital camera having a help switch associated therewith, according to the present invention.

FIG. 2 is an exemplary rear view of the display of the digital camera of FIG. 1, wherein the camera is in a first help mode, according to the present invention.

FIG. 3 is an exemplary rear view of the display of the digital camera of FIG. 1, wherein the camera is in a second help mode, according to the present invention.

FIG. 4 is an exemplary rear view of the display of the digital camera of FIG. 1, wherein the camera is in a third help mode, according to the present invention.

### DETAILED DESCRIPTION

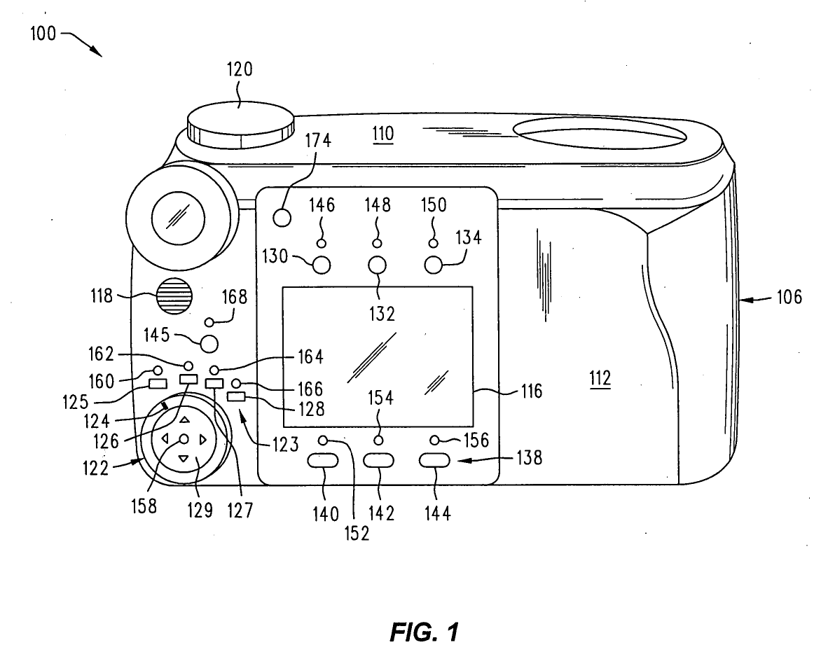

FIGS. 1-4, in general, illustrate a digital camera 100 of the type having the ability to perform at least one function. The digital camera 100 may comprise a display device 116 and a first switch 174, sometimes referred to herein as a help switch. The first switch 174 may have a first operative position and a second operative position. Information describing the use of the at least one function is displayable on the display device 116 when the first switch 174 is switched from the first operative position to the second operative position.

FIGS. 1-4 also, in general, illustrate a method of obtaining information relating to at least one function associated with a digital camera 100. The method may comprise toggling a first switch 174 associated with the digital camera 100. The method may further comprise displaying information pertaining to the at least one function associated with the digital camera 100 on a display device 116 associated with the digital camera 100 upon the toggling of the first switch 174.

FIGS. 1-4 also, in general, illustrate a digital camera 100 that may comprise a first switch 174, a display device 116, a computer, and a computer-readable medium. The first switch 174 may have a first operative position and a second operative position. The computer-readable medium may be operatively associated with the computer. The computer-readable medium may contain instructions for controlling the computer and the digital camera 100 by detecting the first switch 174 being toggled from the first operative position to the second operative position. The instructions may further include displaying information on the display device 116 pertaining to the operation of the digital camera 100 upon the detecting of the first switch 174 being toggled from the first operative position to the second operative position.

Having generally described the digital camera 100, it will now be described in greater detail.

A rear perspective view of the digital camera 100 is shown in FIG. 1. The digital camera may be incorporated into a housing 106. A top side 110 and a rear side 112 of the housing 106 are shown in FIG. 1. The rear side 112 of the housing 106 may have a display device 116 (sometimes referred to simply as a display), such as a conventional liquid crystal display, mounted therein. The rear side 112 of the housing 106 may also have a speaker 118 mounted therein. As described in greater detail below, the digital camera 100 may also have a plurality of knobs and switches associated therewith.

The aforementioned plurality of switches and knobs associated with various functions of the digital camera 100 may extend through the housing 106. In the non-limiting embodiment of the digital camera 100 illustrated in FIG. 1, a knob 120 may serve to turn the digital camera 100 on and off. A switch, not shown, associated with the knob 120 may serve to cause the digital camera 100 to capture an image in a manner similar to a film-type camera taking a picture. Another knob 122 may serve to cause the digital camera 100 to enter various operating modes. In the non-limiting embodiment described herein, the knob 122 may provide for the digital camera 100 to enter one of four modes. A first mode provides for capturing images, a second mode provides for reviewing captured images, a third mode provides for file management of stored images, and a fourth mode provides for downloading images to a computer or other processing device. It should be noted that other operating modes may be associated with the digital camera 100. Accordingly, more or less than the four operating modes described herein may be associated with the digital camera 100.

Indicia 123 printed onto the rear side 112 of the housing 106 may indicate the operating modes of the digital camera 100. More specifically, the operating modes of the digital camera 100 may be entered by rotating the knob 122 so that a pointer 124 on the knob 122 points to the indicia corresponding to the desired mode of the digital camera 100. In the non-limiting embodiment described herein, a first indicium 125 may be indicative of the first mode. A second indicium 126 may be indicative of the second mode. A third indicium 127 may be indicative of the third mode. A fourth indicium 128 may be indicative of the fourth mode. Accordingly, the digital camera 100 may be entered into one of these modes by aligning the pointer 124 with the appropriate indicia.

In the non-limiting embodiment described herein, the knob 122 encompasses a four-way rocker switch, sometimes referred to herein as an input device or navigator 129. As described below, the navigator 129 may have a plurality of toggle switches (not shown) that cause icons or other objects displayed on the display 116 to move. As shown by arrows on the navigator 129, an icon displayed on the display 116 may be moved up, down, left, or right depending on the portion of the navigator 129 that is pressed. The navigator 129 may also serve move a cursor displayed on the display 116 in addition to providing an interface for entering data into the digital camera 100.

A menu switch 130 may extend through the rear side 112 of the housing 106. Toggling, switching, or otherwise causing the menu switch 130 to change between operative positions may cause different menus to be displayed on the display 116 depending on the mode in which the digital camera 100 is operating. For example, one menu may appear when the digital camera 100 is in a mode to capture images and a second menu may appear when the digital camera 100 is in a mode to manage files. Other switches may be used to manipulate the menus as is described in greater detail below.

A display switch 132 may also be associated with the digital camera 100. The display switch 132 may cause the display 116 to display real-time images that are being captured by the digital camera 100. For example, pressing the display switch 132 may enable a user to view the display 116 rather than look through a view finder in order to select an image to be captured by the digital camera 100. Pressing the display switch 132 a second time may cause the display 116 to display information relating to an operational mode of the digital camera 100. An audio switch 134 may serve to record sounds associated with images. For example, a user may capture an image of a scene and add audio to describe the location of the scene by pressing the audio switch 134 while talking.

A plurality of soft switches or soft keys 138 may extend through the housing 106 of the digital camera 100. The soft keys 138 may function in conjunction with the display 116 to operate various functions of the digital camera 100. For example, when the knob 122 is switched to place the digital camera 100 in a file management mode, the menu switch 130 may serve to allow the user to select menus associated with the file management mode. The soft keys 138 may then serve to allow the user to choose specific actions within the selected menu to manage files. In one example, menus and the like are displayed on the display 116 so as to correspond to the locations of the soft keys 138. Pressing one of the soft keys 138 activates the portion of the menu corresponding to the pressed soft key. The soft keys 138 are referenced individually as a first soft key 140, a second soft key 142, and a third soft key 144. It should be noted that the use of three soft keys 138 is for illustration purposes and that any number of soft keys 138 may be used within the digital camera 100.

A transmit or send switch 145 may extend through the housing 106 of the digital camera 100 and may serve to cause image data representative of an image or plurality of images to be transmitted from the digital camera 100 to another electronic device. For example, an image captured and displayed on the display 116 may be transmitted to a printer or a personal computer by pressing the send switch 145. A cable or infrared data link may serve to transmit the image data to the other electronic device.

It should be noted that the switches described above may be conventional push-type electrical switches, such as conventional buttons. The switches and knobs and their associated functions described above are for illustration purposes only and it is to be understood that the digital camera 100 may have other knobs, switches and functions associated therewith.

The digital camera 100 may have a plurality of illumination devices, such as conventional lights or light emitting diodes associated with the above-described switches and knobs. A menu light 146 may be located proximate and associated with the menu switch 130. A display light 148 may be located proximate and associated with the display switch 132. An audio light 150 may be located proximate and associated with the audio switch 134. A first soft key light 152 may be located proximate and associated with the first soft key 140. A second soft key light 154 may be located proximate and associated with the second soft key 142. A third soft key light 156 may be located proximate and associated with the third soft key 144. A navigator light 158 may be located within or otherwise associated with the navigator 129.

With respect to the knob 122, a plurality of lights may serve to indicate the mode of the digital camera 100 based on the setting of the knob 122. Individual lights may be located proximate individual indicia 123 as described below. In the non-limiting example illustrated in FIG. 1, a capture light 160 may be proximate the first indicium 125 and may illuminate when the digital camera 100 is in a mode to capture an image, which is the first mode. It should be noted that some embodiments of the digital camera permit capturing images in any mode. A review light 162 may be proximate the second indicium 126 and may illuminate when the digital camera 100 is in a mode to review captured images, which is the second mode. A file manager light 164 may be proximate the third indicium 127 and may illuminate when the digital camera 100 is in a file managing mode, which is the third mode. A connection light 166 may be proximate the fourth indicium 127 and may illuminate when the digital camera 100 is in a mode to connect to a peripheral device, such as a printer or computer, which is the fourth mode. The lights associated with the knob 122 may also illuminate in order to provide information as to the use of the digital camera 100 as described below. It should be noted that any number of lights or other illumination devices may be located proximate the indicia 123 described above or other indicia, not shown, located on the digital camera 100.

In addition to the above-described switches, lights, and knobs, the digital camera 100 may have a help switch 174 associated therewith. Pressing or otherwise toggling the help switch 174 may cause the digital camera 100 to enter one of several “help modes” of operation. The help modes serve to inform the user of various functions associated with the digital camera 100. The help modes may also serve to cause the digital camera 100 to guide a user in performing various functions associated with the digital camera 100.

The digital camera 100 may have a processor and memory, not shown, located therein. The processor may perform a plurality of functions, including detecting the toggling of the switches, outputting data to be displayed on the display 116, outputting data to the speaker, and processing image data. The memory may store image data representative of captured images. The memory may also store settings of the digital camera 100. For example, a user may use the above-described functions via the switches to establish a default device, such as a specific model of printer, to which data is output. The memory may store the device as a default so that the processor will process the image data to be output to the previously selected output device. In addition, the memory may store software that the processor runs in order to operate the functions of the digital camera 100. As described in greater detail below, the software may enable the digital camera 100 to operate in the help modes and to display information regarding the operation of various functions of the digital camera 100.

Having described some of the functions associated with the digital camera 100, the operation of the digital camera 100 will be described. In particular, the operation of the digital camera 100 in the help mode will now be described. It should be noted that the help modes described herein are for illustration purposes only and that the digital camera 100 may be capable of having other help modes associated therewith.

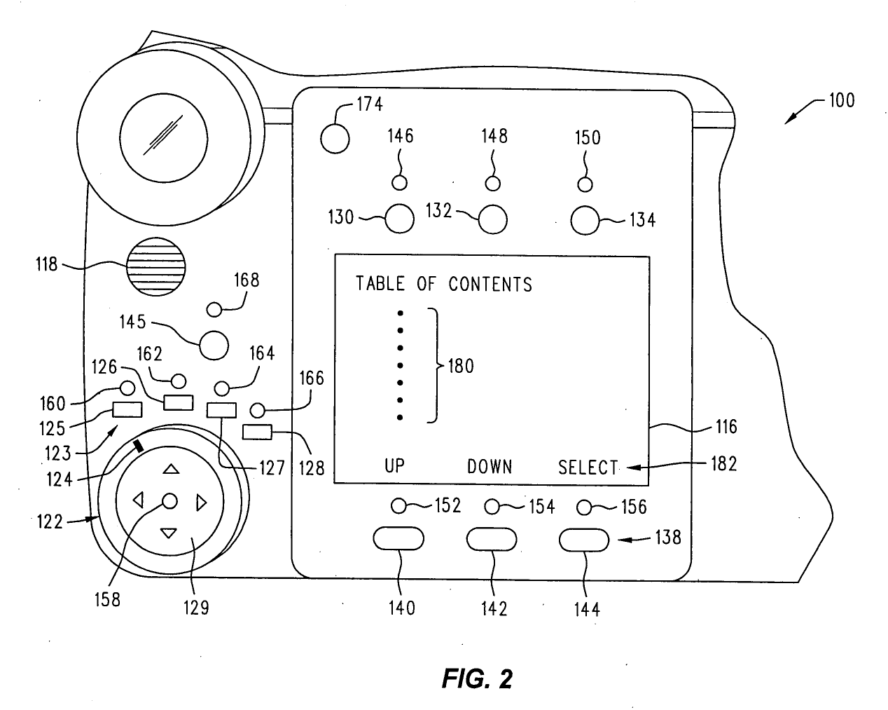

A partial rear view of the digital camera 100 is illustrated in FIG. 2. The digital camera 100 illustrated in FIG. 2 is in a first help mode. Placing the digital camera 100 in the first help mode may be achieved by pressing and releasing the help switch 174. As summarily described above, the digital camera 100 may have the ability to enter several different help modes which are described below. In the first help mode illustrated in FIG. 2, a table of contents is displayed on the display 116. Below the table of contents label, a list 180 of items that correspond to various functions may be displayed. The items in the list 180 may refer to functions that the digital camera 100 is capable of performing, such as entering a macro mode. One item of the list 180 may be highlighted. For example, the highlighted item may be displayed darker than the other items in the list 180 as described below. Instructions 182 may be displayed below the list 180 that correlate with the soft keys 138. For example, the instruction “UP” may be associated with the first soft key 140, the instruction “DOWN” may be associated with the second soft key 142, and the instruction “SELECT” may be associated with the third soft key 144. In one embodiment of the digital camera 100, movement of the highlighted item and selection of the highlighted item is achieved by pressing portions of the navigator 129.

A user may scan the list 180 of items in the table of contents by using the first soft key 140 and the second soft key 142. Pressing the first soft key 140 may cause the list 180 to scan up and pressing the second soft key 142 may cause the list 180 to scan down. More specifically, the highlighted portion of the list 180 may move up and down, thus highlighting different items. When the desired item on the list 180 is highlighted, the user may press the third soft key 144 which causes the display 116 to display text information pertaining to the item selected. More specifically, the display 116 may display information pertaining to the function of the digital camera 100 associated with the selected item in the list 180. When the information is displayed, the text may be scanned up by depressing the first soft key 140 and down by depressing the second soft key 142. The user may return to the table of contents by pressing the third soft key 144. For example, a label, not shown, may be displayed proximate the third soft key 144 when the text is displayed and may indicate that pressing the third soft key 144 causes the display 116 to display previously displayed material. In one embodiment, the display 116 displays a sub-table or a more detailed table of contents upon the toggling of a soft key 138.

The example of the table of contents described above requires a user to scan through the list 180 of items in order to obtain information which may be helpful for obtaining information pertaining to various functions of the digital camera 100. In another example of the operation of the help modes, a user may enter the above-described help modes then press one of the above-described switches. The display 116 will then display information pertaining to the functions accessible by way of the pressed switch. For example, a user may press the display switch 132, which will cause the display 116 to display information pertaining to the display switch 132.

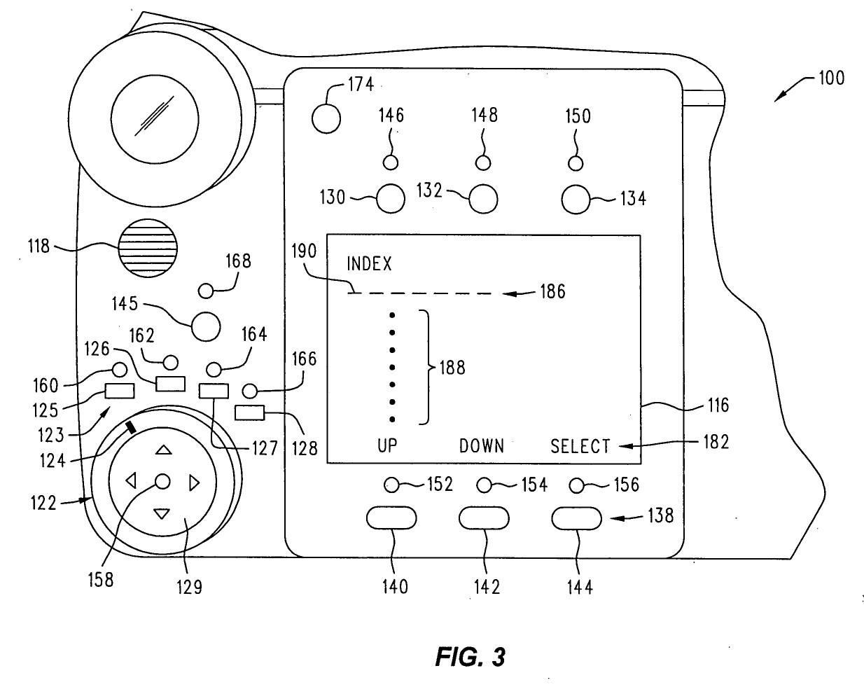

Another example of the help mode of the digital camera 100 is illustrated in FIG. 3 which shows the display 116 displaying a searchable index. The searchable index may be achieved by pressing the help switch 174 two times within a fixed period and is referred to herein as a second help mode of the digital camera 100. The display 116 may display a plurality of character blanks 186 and a list 188 of help items. The character blanks 186 may initially appear blank or underscored with a first blank 190 initially flashing. A user may insert a character in place of the first blank 190 by moving the navigator 129. For example, pressing the navigator 129 upward may cause characters to increment in the first blank 190. Pressing the navigator 129 downward may cause characters to decrement in the first blank 190. Pressing the navigator 129 toward the right may cause a blank to the right to flash and pressing the navigator 129 toward the left may cause a blank to the left to flash. As characters are entered into the character blanks 186, the list 188 may display help topics that correspond to the entered characters. The user may then scan the list 188 by pressing either the first soft key 140 or the second soft key 142 as described above. When a desired topic is highlighted on the display 116, the user may press the third soft key 144 to display text information regarding the topic as was described above with reference to the first help mode.

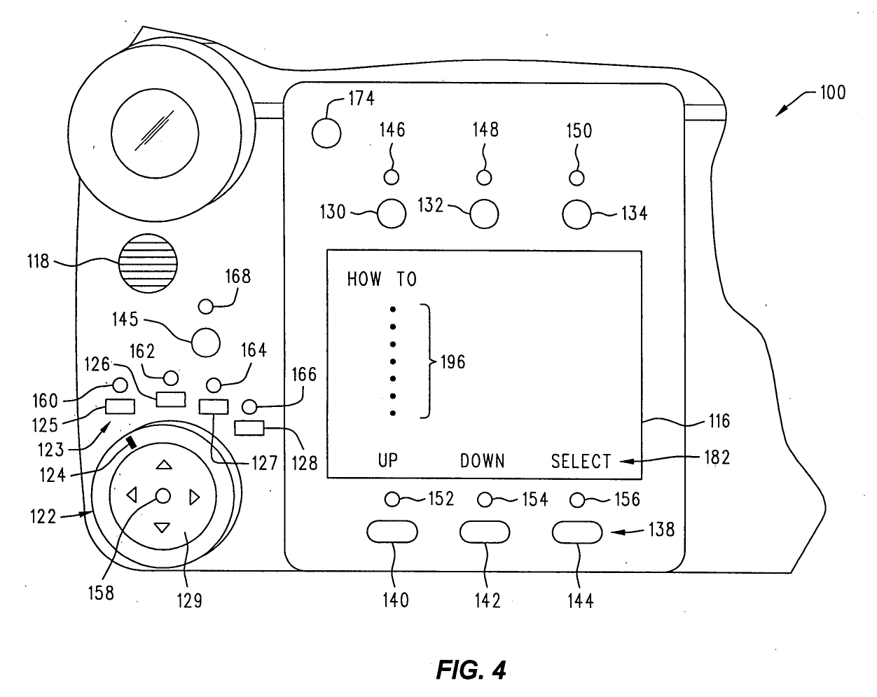

Another help mode is illustrated in FIG. 4 and is sometimes referred to as the third help mode. The digital camera 100 may, as a non-limiting example, enter the third help mode by successive toggling or switching of the help switch 174. In the third help mode, the display 116 may display a “how to” list 196. The how to list 196 may contain functions and the like that the digital camera 100 is capable of performing. A user may highlight and select an item on the list 196 in order to obtain information pertaining to the use of the digital camera 100. For example, the how to list 196 may include items such as how to use the digital camera 100 in a macro mode or how to download image data. A user may highlight an item from the how to list 196 by pressing either the first soft key 140 or the second soft key 142 as described above. When the desired item is highlighted, the user may select the item by pressing the third soft key 144. When the item is selected, information is displayed on the display 116 that instructs the user on how to perform the selected task.

The help modes have been described above as presenting information by causing text to be displayed on the display 116. In one embodiment of the digital camera 100, the speaker 118 may audibly present the information to the user. The audible presentation of information may be in addition or as an alternative to the above-described printed text. As the information is presented to the user, the lights associated with switches or knobs used in conjunction with the described functions of the digital camera 100 may illuminate. For example, if the operation of a function requires turning the knob 122 so the digital camera 100 enters the capture mode, the capture light 160 may illuminate as this portion of the task is being presented to the user. Accordingly, the user knows to turn the knob 122 so as to put the digital camera 100 in the capture mode.

The digital camera 100 described above provides for an easy presentation of help information. Accordingly, a user may access information pertaining to the functions associated with the digital camera 100 simply by pressing the help switch 174. Conventional digital cameras do not have the help modes described above and do not provide for easy access to information pertaining to the functions of the digital camera.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A digital camera comprising:
a display; and
a help switch that when actuated causes the digital camera to enter a help mode and display, on said display, help information that informs a user of various functions associated with operating said digital camera.

2. The digital camera of claim 1, wherein said help information includes a table of contents relating to the operation of said digital camera.

3. The digital camera of claim 2, wherein said table of contents comprises a list of items, and wherein at least one item of said list of items is selectable.

4. The digital camera of claim 1, wherein the help information includes a searchable index.

5. The digital camera of claim 1, wherein said help information includes a list of help items.

6. The digital camera of claim 5, wherein at least one of said items of said list of help items is selectable.

7. The digital camera of claim 1, wherein said help mode enables the user to enter characters and display help topics that correspond to said entered characters.

8. The digital camera of claim 1 and further comprising a processor and an input device, said processor being operatively connected to said display device and said input device, wherein said input device is adapted to transmit at least one signal to said processor, and wherein said display device is adapted to display at least one character representative of said at least one signal transmitted to said processor by said input device.

9. The digital camera of claim 1 and further comprising a second switch, said second switch having a first operative position and a second operative position, and wherein said display displays information related to at least one function associated with said second switch when said second switch is toggled between said first operative position and said second operative position and when said digital camera is in said help mode.

10. The digital camera of claim 1 and further comprising a second switch and an illumination device associated with said second switch, said illumination device being illuminatable in response to said help switch switching from said first operative position to said second operative position.

11. The digital camera of claim 1 and further comprising an audio device, said audio device being activated when said help switch is switched from said first operative position to said second operative position.

12. A method of obtaining information relating to at least one function associated with a digital camera, said method comprising:
toggling a first switch associated with said digital camera; and
audibly presenting information pertaining to said at least one function associated with said digital camera by way of an audio device associated with said digital camera upon said toggling of said first switch.

13. The method of claim 12 and further comprising toggling a second switch, wherein said function is related to said second switch.

14. The method of claim 12, wherein said function is related to a second switch and further comprising illuminating an illumination device associated with said second switch.

15. The method of claim 12, wherein the audible information includes a table of contents relating to the operation of said digital camera.

16. The method claim 12, wherein said audible information includes a list of help items.

17. A method of obtaining information relating to at least one function associated with a digital camera, said method comprising:
toggling a help switch associated with said digital camera; and
displaying information pertaining to said at least one function associated with said digital camera on a display device associated with said digital camera upon said toggling of said first switch.

18. The method of claim 17 and further comprising presenting information relating to said at least one function associated with said digital camera by way of an audio device associated with said digital camera upon said toggling of said first switch.

19. The method of claim 17, wherein said displaying comprises displaying a list of items and further comprising:
selecting one item of said list of items; and
displaying information related to said one item of said list of items.

20. The method of claim 17 and further comprising:
entering at least one character into said digital camera by way of an input device;
displaying a list of at least one item corresponding to said at least one character;
selecting at least one item of said list; and
displaying information pertaining to said at least one item.
